(19) United States
(12) Patent Application Publication
(10) Pub. No.: US 2008/0043025 A1
(43) Pub. Date: Feb. 21, 2008

(54) Using DISC to Evaluate The Emotional Response Of An Individual

(76) Inventors: Afriat Isabelle, Plainview, NY (US); Rafailovich Miriam, Plainview, NY (US)

Correspondence Address: THE ESTEE LAUDER COS, INC, 155 PINELAWN ROAD, STE 345 S, MELVILLE, NY, 11747, US

(21) Appl. No.: 11/841,076

(22) Filed: Aug. 20, 2007

Related U.S. Application Data
(60) Provisional application No. 60/823,060, filed on Aug. 21, 2006.

(51) Int. Cl. G06T 13/00

(52) U.S. Cl. 345/473

(57) ABSTRACT

The present invention comprises the use of Digital Image Speckle Correlation (DISC) to map facial deformations due to voluntary and/or involuntary, often subtle, facial expressions. The facial expressions may be the result of a response to internal or external stimuli. It is possible to develop quantitative and qualitative characterizations of the individual's response. The techniques of the present invention can be used to extend and improve the FACS, which includes assigning human emotions to facial expressions. It is also possible to use test subject feedback to correlate facial expressions to human emotion.

This application claims the benefit of U.S. 60/823,060, filed Aug. 21, 2006.

### FIELD OF THE INVENTION

The present invention pertains to the field of human expression characterization. Specifically, the present invention pertains to methods of characterizing the emotional response of a human subject to internal or external stimuli.

### BACKGROUND

Emotions involve physiological responses that are regulated by the brain. Among these responses, is the muscular activity of facial expression. Human facial expression can be very subtle. Therefore, means for describing and interpreting the facial expressions of another must be very sensitive. The Facial Action Coding System (FACS) [1, 2] is a human observer-based system designed to catalog and classify all human facial expressions and their relation to human emotions. Viewing videotaped facial behavior in slow motion, trained observers can manually code all possible facial displays, which are referred to as action units. Action units may occur individually or in combinations. FACS consists of forty-four action units. Thirty are anatomically related to contraction of a specific set of facial muscles. As an example of the coding stipulated in the FACS standard, a voluntary smile is a smile achieved solely by the action of the zygomaticus major muscle. An involuntary smile generally involves the zygomaticus major, as well as the orbicularis oculi and pars orbitalis muscles. Generally, sincerity may be associated with the involuntary smile and insincerity with the voluntary smile.

Despite the existence of FACS, and perhaps, other human expression coding systems, facial expression can be so subtle that even a trained observer may not be able to detect an involuntary facial expression. Thus, a human-observer based system would fail to perceive and/or analyze the emotions associated with an undetected involuntary facial expression. It is therefore desirable to develop new techniques, and/or to extend FACS, to improve human facial expression analysis.

Mechanical properties of skin and other soft tissues have been investigated using various techniques common in mechanical engineering and materials testing. Many of these techniques measure the surface displacement and strain of a test sample under constant load. From these measurements, intrinsic properties such as elasticity, Young's modulus, tensile strength and hardness may be derived. These techniques have even been applied to living tissue with the aim of finding local discontinuities in the tissue. Such discontinuities may be indicative of a pathological process at work, altering the mechanical properties of the tissue. Some measurements of this type use invasive contact methods and equipment generally associated with materials testing, for example, a durometer for hardness testing, a strain gauge for tensile testing, suction cup and torsional methods for elasticity, etc. Often, it is not practical to perform these tests in vivo, and thus, they are inadequate to correlate facial expressions to emotions.

Less invasive methods of measuring mechanical properties of skin include optical methods. Recently, a non-contact, in situ technique for measuring skin stretch was reported using the optical properties of the skin and the reflection of light from the skin surface (see, “Measurement Of Skin Stretch Via Light Reflection” Guzelsu, et al.; Journal of Biomedical Optics January 2003, vol 8, 1, 81-86). The premise in that article is that as the skin is stretched, the roughness of the tissue is reduced, resulting in a smoother reflecting surface and an increase in polarized light reflected from the skin. This technique can measure the changes that takes place in light intensity due to applied skin stretch, but the measurement is only a gross average over the entire skin sample. In contrast, it is known that skin, under tension, behaves anisotropically. Because of this, measurements of the skin's response as a gross average over the whole affected area, are of limited value. Subtle movements may go undetected. This reference does not disclose or suggest the in vivo techniques of the present invention, nor does it disclose a method of correlating emotions to externally introduced stimuli. Furthermore, methods of developing improved odorous compositions are not disclosed.

Various forms of digital image correlation have been developed, but generally, they all seek to measure the displacement and deformation gradients caused by a load applied to a surface. They do this by correlating small regions of a digital image made after deformation with those same regions on a digital image made before deformation. When this correlation is carried out at many points over the whole image of the specimen under investigation, it yields a vector displacement field for the deformed surface. From this displacement field, stress, strain and Young's modulus may be computed.

One digital image correlation technique, in particular, is digital image speckle correlation. Digital image speckle correlation (DISC) has been in use and development for more than two decades to analyze the response of materials to stress and the environment. In principle, all types of materials, living and non-living, may be studied with DISC. Generally, geometric features are identified in the field of a digital image before deformation and then these features are tracked to their new location in the image field after deformation. By this tracking, a vector displacement field for the deformed surface can be constructed. In the conventional method of DISC, reflective materials (speckles) are randomly distributed on the surface under examination. The speckles provide easy-to-track geometric features on the surface of the test specimen. After capturing one digital image of the undeformed surface and one digital image of the deformed surface, the images are divided into subsets. The subsets on the image of the undeformed surface are matched to the corresponding subsets on the image of the deformed surface. This is done through sophisticated numerical computer analysis, comparing patterns of light intensity in the before and after photos. The coordinates of the center points of each pair of subsets define a displacement vector which describes the average displacement of the subset as a result of the deformation. The displacement vectors can be resolved into vertical and horizontal components and that information may be represented as vertical and horizontal projection maps. Using numerical differentiation, the normal strain along either direction may be obtained.

In “Determining Mechanical Properties of Rat Skin With Digital Image Speckle Correlation” (Guan, et al., Dermatology, vol 208, no. 2, 2004, p. 112-119), the contents of which are herein incorporated by reference, there is described an in vitro application of DISC on samples of rat skin. Three sections of skin were tested: freshly excised skin; skin allowed to rest 24 hours after being excised; and skin pre-treated for 24 hours with a commercially available cosmetic anti-wrinkle moisturizer. The skin sections were stretched in a tensile testing machine at a constant rate of 0.508 mm per minute. The speckle material consisted of 24 μm silicon carbide and talc material, which provide a high contrast black and white surface. Digital images were taken with a Kodak MegaPlus 1.6i charged-coupled device camera, having a resolution 2,029×2,048 pixels. For each skin sample, the tensile stress, tensile strain, ultimate strain, Young's modulus and break strength were determined. The article concludes, in part, that the moisturizer efficiently slowed down the loss of elasticity in the rat skin. The article further suggests, but does not describe, the use of DISC, in vivo, to monitor changes in skin elasticity, which may provide a means of predicting wrinkle formation. The article merely mentions, but does not describe, that the skin may be put under stress using a gas loading electrodynamometer. The article does not disclose or suggest methods of measuring involuntary facial response to external stimuli with a DISC-like technique. Furthermore, the article does not disclose or suggest a method of correlating involuntary facial response to emotion. This reference does not disclose or suggest the in vivo techniques of the present invention. Furthermore, methods of developing improved odorous compositions are not disclosed.

A modified DISC technique has been successfully applied in vivo, using the pores of the skin for tracking deformation, rather than speckle material. (See, “Dynamic Facial Recognition With DISC: Identify the Enemies”, paper presented at the meeting of the American Physical Society, Mar. 22-26, 2004, Montreal). The voluntary musculature under the skin of the face provided the deformation of the skin and this reference describes a successful facial recognition method. The article does not disclose or suggest methods of measuring involuntary musculature facial response to external stimuli with a DISC-like technique. In fact, in the technique of the reference, involuntary movements were to be minimized as much as possible. Furthermore, the article does not disclose or suggest a method of correlating involuntary facial response to emotion. This reference does not disclose or suggest the in vivo techniques of the present invention. Furthermore, methods of developing improved odorous compositions are not disclosed.

In “Investigations of Facial Recognition and Mechanical Properties of Aging Skin Through Digital Image Speckle Correlation” (submitted to the Intel Science Talent Search, November, 2004) there is disclosed an in vivo application of DISC technology to human facial skin. It was determined that age-related changes in the skin (for example, loss of elasticity) can be observed by Examining a cross section of a vector displacement map. The map is created from vector displacement data obtained in a DISC-like procedure.

None of the foregoing discloses the use of a non-invasive, in vivo, DISC-type data collection system to measure involuntary facial response to external stimuli, nor to methods of correlating involuntary facial response to emotion, nor to methods of developing improved odorous compositions.

### OBJECTS OF THE INVENTION

A main object of the present invention is to provide a non-invasive, in vivo method of measuring involuntary facial responses to external stimuli.

A main object of the present invention is to provide a non-invasive, in vivo method of measuring involuntary facial responses to odor.

A main object of the present invention is to provide a non-invasive, in vivo method of mapping voluntary facial movement.

Another object of the present invention is to provide an improved, non-invasive, in vivo method of correlating facial movement to emotional state.

Another object of the present invention is to improve FACS-based human facial expression analysis.

Another object of the present invention is to provide a non-invasive, in vivo method of developing improved odorous compositions.

Another object is to provide methods of evaluating the efficiency of a person's sense of smell.

### DESCRIPTION OF THE FIGURES

FIG. 1 is a schematic representation of a digital image speckle correlation system used in the present invention.

FIG. 2 is an example of a vector displacement map.

FIGS. 3a and 3b are, respectively, examples of vertical and horizontal projection maps, in this case, projections of the map of FIG. 2.

Vector maps that correspond to closing and opening the eye, are shown in FIGS. 4a and 4b.

FIG. 5 is a vector map associated with the motion of smiling.

FIG. 6 is a baseline (no stimuli) vector displacement map generated by DISC.

FIG. 7 is a vector displacement map generated by DISC using a before image (no stimuli) and an after image (exposure to lavender).

FIG. 8 is a vector displacement map generated by DISC, from a before image (no stimuli) and an after image (exposure to yeast extract).

### SUMMARY OF THE INVENTION

The present invention comprises the use of Digital Image Speckle Correlation (DISC) to map facial deformations due to voluntary and/or involuntary, often subtle, facial expressions. Unlike in vitro methods and unlike invasive, in vivo methods that tension the skin with an apparatus, the present invention relies on muscular response to deform the skin. The present invention is also different from previously reported in vivo methods that use voluntary muscular actions, rather than involuntary. From before and after images, it is possible to develop quantitative and qualitative characterizations of human facial expressions that result from internal or external stimuli. The techniques of the present invention can be used to extend and improve the FACS, which includes assigning human emotions to facial expressions. It is also possible to use test subject feedback to correlate facial expressions to human emotions. Once a sufficiently large database is compiled, of characterized facial expressions and test subject feedback, then it will be possible to infer the emotional state of a subject by observing their facial expression response, absent any feedback from the subject. Furthermore, by systematically cataloging facial expression responses to standardized external stimuli, it is also possible to evaluate the relative efficiency of a person's stimulated sensory pathway.

### DETAILED DESCRIPTION OF THE INVENTION

A DISC technique of the present invention is in vivo, while being completely non invasive and characterizes in real time, the behavior of the skin itself in response to external stimuli. For example, techniques of the present invention may be used to directly measure the immediate response of the skin to olfactory stimulation. Such a technique provides a great advantage in quantifying and qualifying consumer perceptions, in a meaningfully comparative fashion. The DISC technique of the present invention may pick up subtle, visually imperceptible reactions that correlate to emotional reactions of which the consumer may or may not be aware.

Likewise, the method of the present invention is different from a method described in applicants' co-pending application U.S. Ser. No. 11/296,236, herein incorporated by reference. In the '236 reference, the displacement of the skin in before and after images was caused by the voluntary musculature of the individual under evaluation. The stimulus was supplied voluntarily by the test subject. In contrast, in the present invention, the skin is not displaced by a voluntary impulse supplied by the test subject, but rather it is displaced by an involuntary response to one or more internal or external stimuli. External stimuli may be odorous, gustatory, auditory, tactile or visual. Internal stimuli may be psychological, neurological, chemical, biological, etc. In all cases, the present invention is concerned with facial expressions that result from an involuntary recruitment of muscle fibers. Here, “involuntary” may be taken to mean that the human individual does not decide in advance to alter his or her facial expression.

Throughout this specification, the terms “comprise,” “comprises,” “comprising” and the like, shall consistently mean that a collection of objects is not limited to those objects specifically recited.

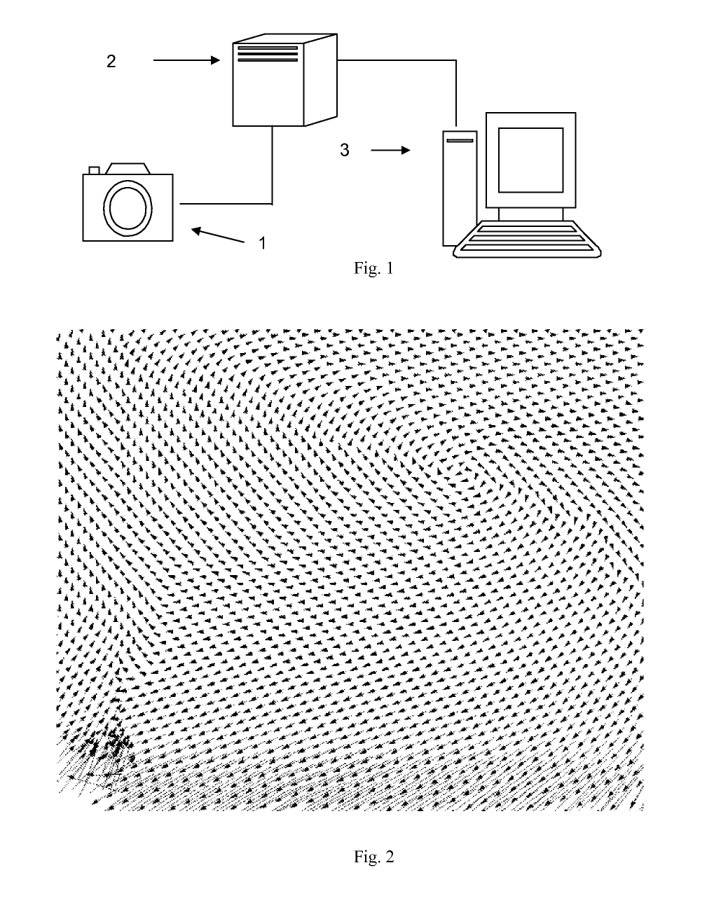

FIG. 1 is a schematic representation of a digital image speckle correlation system used in the present invention. A camera (1) for capturing digital images is a charge-coupled device providing a minimum of four mega pixel resolution. This resolution is sufficient to resolve the pores of human skin, which are the points being tracked in the technique of the present invention. Technically, virtually any feature in the image field may be useful for tracking between images, however, the success of a DISC-type technique depends on having a plethora of features to track. In humans, skin pores fulfill this requirement. Some useful cameras are Canon EOS Rebel Digital camera (6.3 mega pixel resolution), the Toshiba DK-120F CCD camera, the five-mega pixel Canon D60 or Canon Powershot Pro1. Data collected by the camera is pre-processed by a frame grabber (2), such as PIXCI® from EPIX®, and the digitized information is downloaded to a computer (3) for numerical analysis. Many research groups have developed their own software on the DISC technique to suit their own needs. Persons of ordinary skill in the art are capable of developing such software without undue burden. Furthermore, there are also commercially available software applications, one being VIC-2D from Correlated Solutions Inc., (West Colombia, S.C.), with an advertised displacement accuracy of better than one one-hundredth of a pixel. Another supplier of digital image correlation systems and software is Optical Metrology Innovations, Cork, Ireland.

A typical procedure comprises capturing at least two images. A procedure with just two images is described, and easily extended to more than two images. A first image of a surface (i.e. a portion of facial skin) is made before the introduction of the stimulus to be evaluated. As a result of the stimulus, involuntary facial expressions occur. While the skin is in this “deformed” state, a second image is made. Throughout the specification, “deform” means that the skin has assumed a shape that is different from an initial shape or that the pores in the skin have assumed an arrangement that is different from an initial arrangement. Preferably, the surface to be imaged is held motionless during image capture. A harness designed to hold motionless the part of the body containing the area of study may be used. For example, a chin rest or a full head harness may be used to hold a subject's head still. Useful devices of this type are available from Canfield Scientific. It is also preferable that the camera be held immovable during picture taking. A camera stand may be used for this purpose.

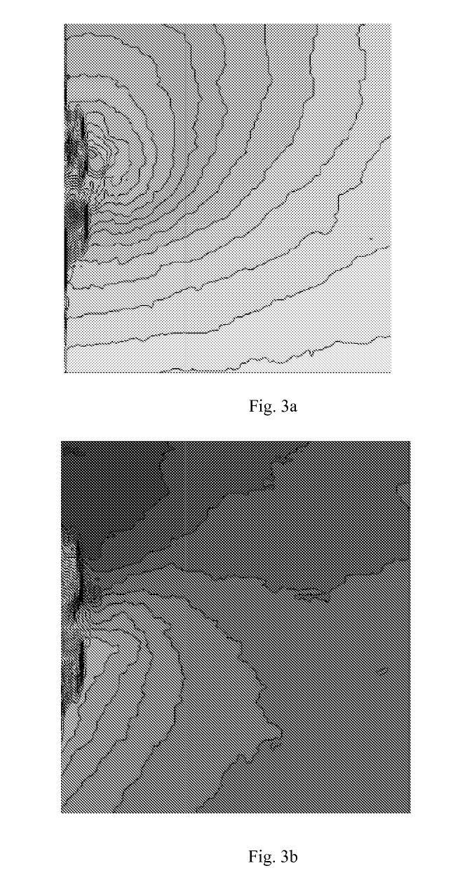

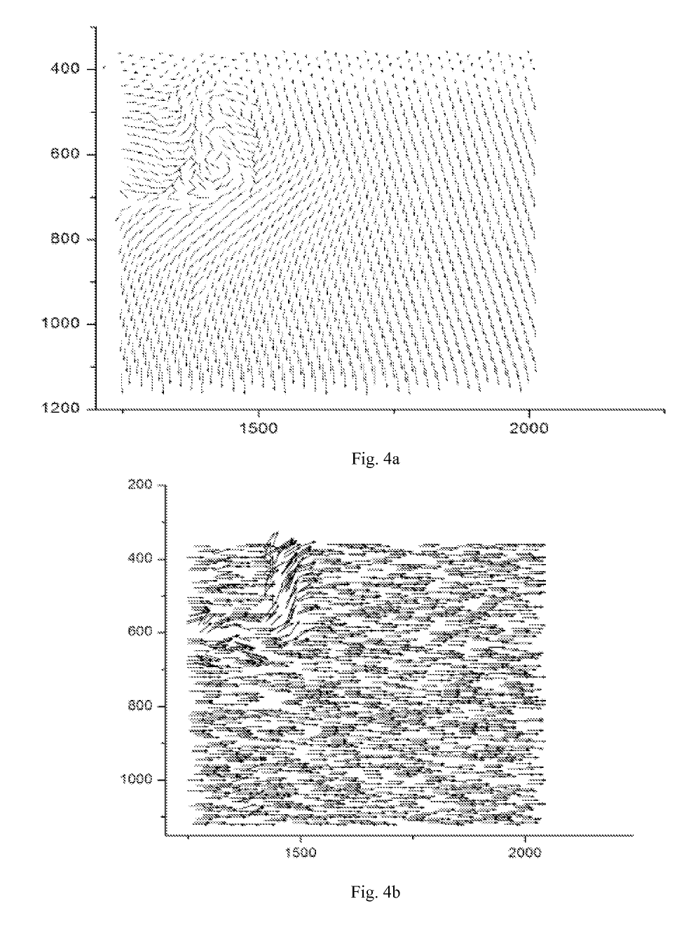

Once the images are acquired, software, such as Photoshop© from Adobe®, is useful for imposing on the images, a boundary of the area to be studied and a reference coordinate system, as well as for obtaining a rough estimate of pore displacement. The boundaries are somewhat arbitrary and may be chosen to define a domain large enough for analyzing several areas of the skin. More sophisticated image analysis software is commercially available. For example, products sold under the OriginLab® label are able to analyze DISC-type digital image data to calculate values for a host of mechanical properties of the material under investigation. The image analysis software determines the coordinates of each pore in the displacement field relative to the reference coordinate system, for the before and after image. From this data, correlations are established between the pores in the before and after images and a field of displacement vectors, as discussed above, may be generated (see FIG. 2). Each displacement vector represents the movement of one pore from its initial to final location. Each pore vector in the field of displacement vectors is resolved into its vertical and horizontal projections, from which vertical and/or horizontal projection maps may be produced. Examples of vertical and horizontal projection maps are shown in FIGS. 3a and 3b, respectively. In the projection maps, the horizontal and vertical axis (not shown) convey the coordinates of any position in the field of study. Areas of constant displacement are color coded in these figures.

By studying the patterns that are captured in the vector displacement maps, the deformation or movement of the skin during involuntary facial expression can be correlated to the underlying musculature. Thus, the muscles recruited to perform a facial expression can be identified. Once the set of muscles is identified, then the facial expression can be identified in the Facial Action Coding System and one or more statements about the emotional state of the individual can be assigned, based on the FACS standard that correlates facial expressions to human emotions. The skin deformations detectable with this DISC technique may be imperceptible to the unaided eye. Thus, the present invention provides a means for extending the work done utilizing FACS alone. Furthermore, where there may be other standards for describing, qualifying or quantifying facial expression, the DISC technique of the present invention may be used to extend the range of expressions that are characterizable. The following example demonstrates the use of the present invention.

Experimental Procedure

Part 1. Voluntary Facial Expressions

Three test subjects, healthy women between eighteen and fifty-five years old participated in this study. During the experiments, the heads of the test subjects were supported on a head rest. First, baseline images of a specific region of the face were acquired using a five-megapixel camera (Canon D60). Next, the subjects were asked to perform different facial movements, such as opening and closing of the eyes and smiling slightly. While holding each facial expression, “after” images were acquired. For each set of images, a vector displacement map of the pore movement was generated. This is done by taking the difference between the final and initial positions of each pore in the field of study. In order to minimize the amplitude of the vector maps, the subjects were asked to perform specific tasks which required little exertion. Areas of the face that were studied included regions around the eye and the mouth.

Outer Canthus Region

The region lateral to the eye was studied by acquiring a first image with the eye opened and a second image with the eye closed. Additionally or alternatively, a first image was acquired with the eye closed and a second image with the eye opened. It is known that the sequence of muscular motion is different when moving the eyelid from opened to closed, as opposed to closed to opened. For example, the corrugator supercilii muscles along with the lateral orbicularis oculi muscles are the primary depressors of the eyebrow, while the frontalis muscle is the primary elevator of the eyebrow. Vector maps that correspond to closing and opening the eye, are shown in FIGS. 4a and 4b. In 4a, a zone of circular motion corresponds to the circular shape of the orbiculari occuli and corrugator supercilii. In contrast, in FIG. 4b the vertical motion near the eye corresponds the vertical shape of the frontalis muscle. Therefore, we can correlate the deformation of the skin with muscular movement and conclude that a vector map of skin displacement follows muscular motion.

Mouth Region

The region of the mouth was studied by acquiring a first image with the mouth at rest and a second image with the mouth slightly smiling. FIG. 5 is a vector map associated with the motion of smiling. From the vector map, we can see that distinct areas of coordinated deformation are visible. Regions of circular motions appear symmetrically in the region near the mouth. By comparing the facial displacement vector map (FIG. 5) to a standard facial muscular diagram, we observe that the areas of greatest displacement of the facial skin correlate to the shape and position of the major muscles involved in smiling. Therefore, we can correlate the deformation of the skin with muscular movement and conclude that a vector map of skin displacement follows muscular motion.

In the case of smiling, the involved muscles are perioral muscles, some of which are the elevators of the upper lip, elevators and depressors of the corner of the mouth, and depressors of the lower lip. The four primary lip elevators are the zygomaticus major and minor, the levator anguli oris and the levator labii superioris muscles. The nasolabial crease is formed by their insertion. The zygomaticus major and zygomaticus minor are long thin muscles that arise from the body of the zygoma and insert into the musculature of the lateral portion of the upper lip. The zygomaticus minor is a shorter muscle and inserts into the midsection of the upper lip. These muscles, along with the levator anguli oris, when contracted, produce the dominant zygomatic smile, the most common smile.

As mentioned before, the FACS coding system consists of forty-four action units. Thirty are anatomically related to contraction of a specific set of facial muscles. Because the vector displacement maps of the present invention closely track the movements of the underlying musculature, the vector displacement maps can be combined with the FACS coding system to develop a more robust method of facial expression analysis and emotional state analysis. Because of the high pixel resolution of the present invention, the method even extends to facial expressions that are too slight to be perceived by the unaided eye.

Part 2. Involuntary Facial Expressions

Three test subjects, healthy women between eighteen and fifty-five years old, were seated in a quiet room. On day one, three baseline images of the face were taken in rapid succession, using a five-megapixel camera (Canon D60). Next, the subjects smelled a lavender extract for thirty seconds. To present the extract to the test subjects, blotters were dipped in a five percent solution of lavender essence in di-propylene glycol. While exposed to the odor, three images were acquired in rapid succession. The test subjects were asked to refrain from voluntary facial movements during the experiments. The experiment was repeated three times and during each experiment, the head of the subject was supported on a head rest. After the procedure, the subjects were interviewed and asked to assess the odor to which they had been exposed. On the second day, the same procedure was followed, except the test subjects were presented with a protein broth, which has a strong proteinaceous, sweaty, amine-like or yeasty odor.

When examined with the unaided eye, the images revealed no facial movement. Qualitative analysis was then performed by generating vector displacement maps and horizontal and vertical projection maps, of the pore speckle patterns of the entire face.

Panelist #1:

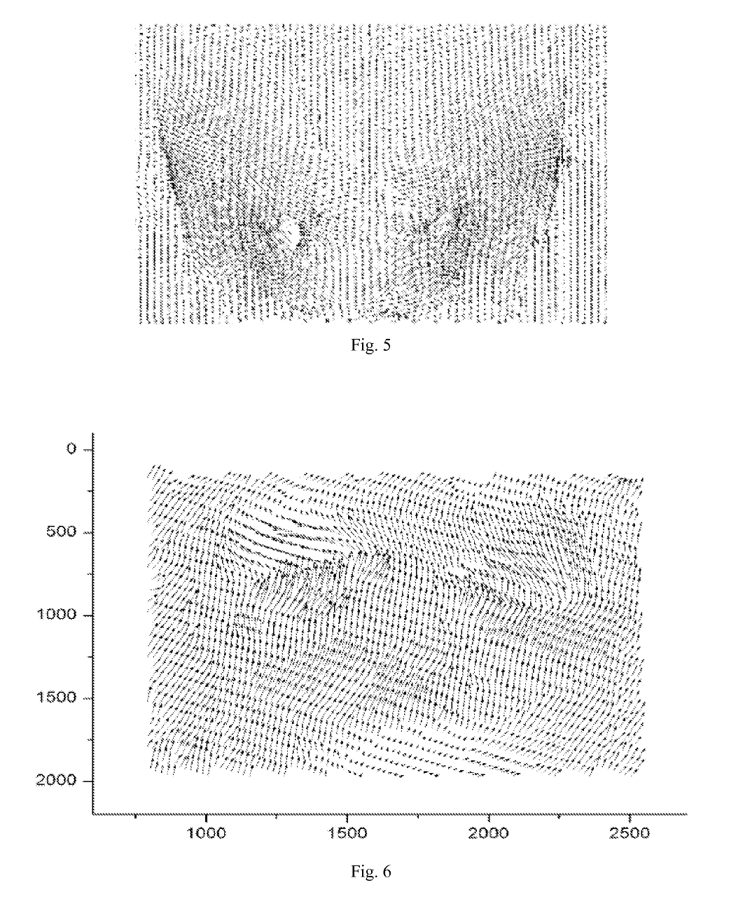

FIG. 6 is a baseline (no stimuli) vector displacement map generated by DISC.

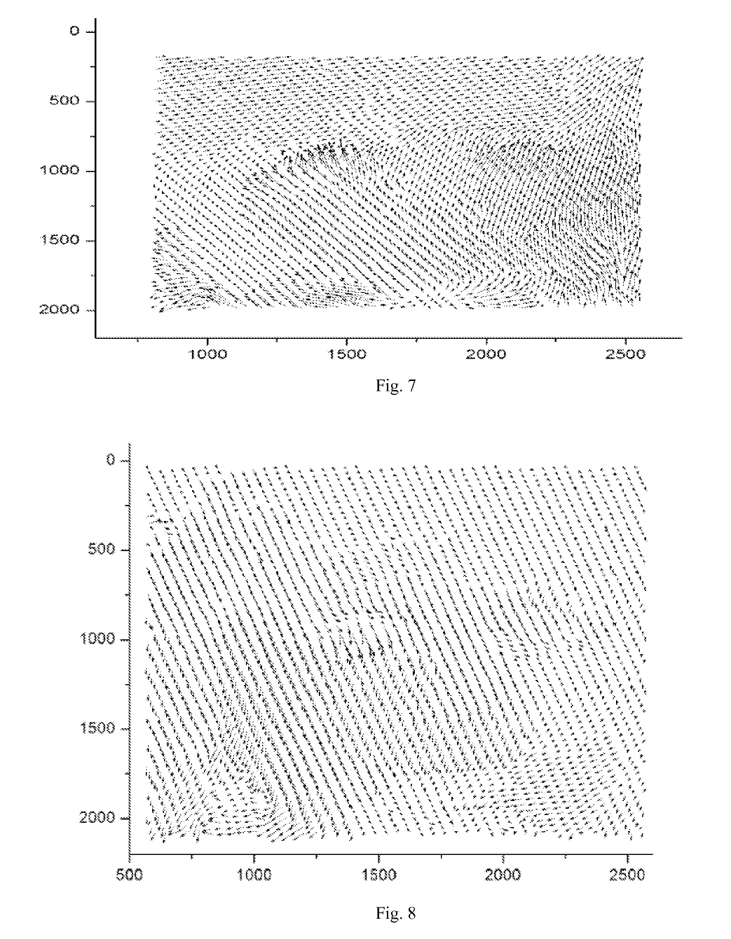

FIG. 7 is a vector displacement map generated by DISC, from a before image (no stimuli) and an after image (exposure to lavender).

FIG. 8 is a vector displacement map generated by DISC, from a before image (no stimuli) and an after image (exposure to yeast extract).

Panelist #1 mentioned that she did not like the yeast extract, and that she liked the lavender extract although it was a little too strong.

In the vector displacement maps (FIGS. 6, 7, 8) one can immediately see vectors following many different directions, indicating facial motion, even though the movements were not perceptible to the unaided eye. A closer examination of the vector maps reveals the shape of a face, and features, such as the eyes, the nose and the mouth, may be distinguished.

The motion associated with the baseline experiments (FIG. 6) demonstrates that there are involuntary facial movements in a standing still position. In the lavender vector map (FIG. 7), around the mouth, the vectors appear to follow the shape of the zygomaticus major. In the Facial Action Coding System, the action unit AU 12 (lip corner pull), corresponding to the contraction of the zygomaticus major is coded positive and considered a positive expression when combined with a minimum intensity. Therefore, the conclusions made by analyzing the different maps, combined with the FACS, are in agreement with the positive statement that the panelist #1 made about the lavender. In contrast, an analysis of the yeast vector displacement map reveals a very different reaction of facial musculature to the yeasty odor. The yeast map reveals vertical displacements in the skin of the low mid-face, that are in a direction opposed to the skin displacements in the lavender displacement map. This observation is in agreement with the statement by the panelist. that she liked the lavender smell, but disliked the yeast smell.

To summarize, we have shown that DISC can detect subtle facial motion associated with involuntary movements. By matching the vector displacement map to muscular activity, the FACS suggests that subject #1 experienced a positive emotion by smelling the lavender and a negative emotion by smelling the yeast extract, which correlates with what she assessed.

Panelist #2

A similar analysis was performed for panelist #2. Panelist #2 assessed that she preferred the lavender smell to the yeast smell.

For panelist #2, the vector displacement maps and horizontal and vertical displacement maps, reveal a lot more motion (or deformation) in the lower mid-face, for the yeast and lavender experiments compared to the baseline (no stimulus), which indicates a reaction to the odors. Also, multiple regions of different directions appeared in the lower mid-face for the yeast experiment compared to lavender and baseline experiments. In this case, the general flow of the vectors at the mouth corners does not follow the shape of the zygomaticus major. It was observed for the yeast extract, that there is a vertical motion at the chin site. According to the FACS, action unit AU17 corresponds to the rise of the chin, which is, correlated with anger or irritation. The vertical displacement maps for the lavender and yeast experiments, showed a marked difference in skin displacement on either side of the chin. Again, by matching the vector displacement to muscular activity and comparing the displacement to the baseline response, FACS suggests that panelist #2 experienced a positive emotion by smelling the lavender and a negative emotion by smelling the yeast, which correlates with what she assessed.

Panelist #3

A similar analysis was performed for panelist #3. Panelist # 3 assessed that she recognized the yeast smell (because she used to work in a bakery) and that it did not bother her. She did not mention any positive or negative comments regarding the lavender smell.

For panelist #3, the vector displacement maps and horizontal and vertical displacement maps, reveal a lot more motion in the low mid-face for the lavender and yeast experiments compared to baseline (no stimulus), which indicates a reaction to the odors. The vertical and horizontal displacement maps for lavender and yeast experiments, were significantly more similar for panelist #3 than for panelists #1 and #2. That is, panelist #3, compared to panelists #1 and #2, expressed less difference in her reaction to the lavender and yeast odors. Thus, the information gleaned from the vector displacement maps is again supported by the panelist's verbal assessment, that the yeast smell did not bother her and no comment on the lavender smell.

### CONCLUSION

The DISC technique of the present invention is useful for correlating skin displacements caused by facial expression to facial muscular activity, whether the muscles are recruited voluntarily or involuntarily and whether the skin displacement is perceptible to the unaided eye or not. We have also shown that facial expressions induced by olfactory stimuli (and by extension, any stimuli) may be mapped. We assume that there is nothing inherently special about using olfactory stimulus and the techniques of the present invention will find use when the stimulus is supplied through the olfactory, auditory, visual, tactile or gustatory pathways. When combined with the Facial Action Coding System standard, the vector displacement maps that are obtained by the techniques of the present invention, reveal information on the emotional state of the individual. That information was confirmed by the self-assessment of the panelists. Thus, the technique has practical applications in the fields of dermatology and cosmetics, as well as psychology, homeland security, law enforcement, and many other applications where an objective measurement of emotional response reveals an individual's preferences, prejudices and emotional state.

As mentioned, the techniques of the present invention can be used to extend and improve the FACS, which attempts to assign human emotions to facial expressions. However, it is also possible to use test subject feedback to correlate facial expressions to human emotions. In principle, it is easy to imagine a relational database of facial expressions characterized with a DISC technique of the present invention. Within the database, the facial expressions are correlated to emotional state, which information is provided by test subject feedback. Once such a database is constructed, it would be possible to infer the emotional state of a subject by observing their facial expression response with the DISC technique of the present invention, without any feedback from the subject.

Furthermore, in principle, it is easy to imagine a relational database of facial expression responses to standardized stimuli, characterized by the DISC technique of the present invention. With such a database, it would then be possible to evaluate the relative efficiency of a person's stimulated sensory pathway. Alternatively, it would be possible to evaluate and characterize an unknown stimulus based on the elicited response. This would be done by finding the most similar response or responses in the relational database and noting which stimuli caused them. Furthermore, any such relational databases could include secondary data such as age, ethnic heritage, economic status, education, health, lifestyle habits and so on. Thus, response to internal or external stimulus may be correlated to any characteristic of interest.

Furthermore, in principle, it is easy to imagine using the techniques of the present invention to evaluate the response of a defined population to a stimulus. By “defined population” we mean any subset of interest of the secondary data. For example, employed, single females, of Hispanic origin. In this case, the stimulus may be a new product to be introduced into the marketplace. Market research is conducted all the time, but generally relies on the test public accurately describing their reaction to the product. The present invention can be used to improve the quality of the data by observing the pure, initial reaction of the test consumer, before he/she has had time to think about a verbal response. When combined with secondary data such as age, ethnic heritage, economic status, education, health, habits and so on, the effect of the proposed product on different demographics could be assessed.

The person of skill in the art may imagine various other applications of the present invention which do not go beyond the spirit of the examples herein disclosed.

What is claimed is:

1. A method of evaluating an emotional state of a human individual, the method comprising the steps of:
having the individual to perceive a stimulus that results in an involuntary altering of the individual's facial expression; and
using a digital image speckle correlation system to gather vector displacement data from the skin of the individual's face.

2. The method of claim 1 wherein the stimulus is an internal or external stimulus perceived by the individual.

3. The method of claim 2 wherein the stimulus is one or more of odorous, gustatory, auditory, tactile, visual or psychological.

4. The method of claim 1 further comprising the steps of:
using the vector displacement data to identify the muscles that were recruited to alter the individual's facial expression; and
using the Facial Action Coding System to correlate the altered facial expression to one or more human emotions.

5. The method of claim 1 wherein the altering of the facial expression is imperceptible to the unaided eye.

6. A non-invasive, in vivo method of emotional state analysis that combines digital image speckle correlation with the Facial Action Coding System, to characterize the emotional state of an individual.

7. The method of claim 6 further comprising a step of confirming the characterization by a self-assessment of the individual.

8. A non-invasive, in vivo method of emotional state analysis that combines digital image speckle correlation with test subject feedback, to characterize the emotional state of an individual.

9. A relational database comprising:
facial expression information, the facial expression information being obtained with a digital image speckle correlation system that gathers skin vector displacement data from human faces of test subjects; and
emotional state information, the emotional state information being obtained by test subject feedback.

10. The use of a relational database according to claim 9 to infer the emotional state of a test subject by observing facial expression response with a digital image speckle correlation system, and without any feedback from the subject.

11. The relational database of claim 9 wherein standardized stimuli are used to induce a facial expression response, which gives rise to the facial expression information.

12. The relational database of claim 9 further comprising secondary data, such as age, ethnic heritage, economic status, education, health and lifestyle habits.

13. The use of a relational database according to claim 12 to evaluate the response of a defined population to a cosmetic or dermatologic product.

14. A cosmetic or dermatologic product made, at least in part, with the aid of a relational database according to claim 12.

15. A non-invasive, in vivo method of measuring involuntary facial responses to external stimuli, the method comprising the steps of:
using a digital image speckle correlation system to gather skin vector displacement data from the human individual's face, before and after an involuntary facial response.

16. The method of claim 15 wherein the involuntary facial response occurs as a response to an internal or external stimulus perceived by the individual.

17. The method of claim 16 wherein the wherein the stimulus is one or more of odorous, gustatory, auditory, tactile, visual or psychological.
